(19) United States
(12) Patent Application Publication
(10) Pub. No.: US 2025/0297667 A1
(43) Pub. Date: Sep. 25, 2025

(54) Damper With Integrated Bumper And Retainer

(71) Applicant: DRiV Automotive Inc., Northville, MI (US)

(72) Inventors: Christopher SEREMENT, Trenton, MI (US); Matthew L. ROESSLE, Northville, MI (US)

(21) Appl. No.: 18/610,406

(22) Filed: Mar. 20, 2024

(51) Int. Cl. F16F 9/58; F16F 9/22

(52) U.S. Cl. CPC F16F 9/58; F16F 9/22

(57) ABSTRACT

A hydraulic rebound stop assembly for a hydraulic damper is provided. The rebound stop assembly includes a movable rod, a retention feature fixed to the movable rod, and a ring circumscribing and slidingly engaging the movable rod. The ring axially extends between a first end surface and an axially spaced apart second end surface. The ring includes an outer wall and an inner wall defining a cavity. The retention feature is at least partially received in the cavity. The ring is axially movable between a first position and a second position. A dimension of the cavity is greater than a dimension of axial travel of the ring between the first position and the second position. In the first position, the retention feature constrains axial movement of the ring in a first direction.

### FIELD

The present disclosure relates to a hydraulic damper.

Specifically, the present disclosure relates to a hydraulic damper having an integrated bumper and retainer.

### BACKGROUND

The statements in this section merely provide background information related to the present disclosure and may not constitute prior art.

A hydraulic damper, and particularly a hydraulic damper of a steering assembly, is a damping mechanism that is used to stabilize or otherwise minimize oscillations of the steering assembly. Typically, hydraulic dampers include a tube defining a reservoir containing hydraulic fluid, an oscillating member or rod extending through at least a portion of the reservoir, and a valve fluidly coupled to the reservoir. The valve defines a hydraulic fluid channel that is capable of selectively permitting hydraulic fluid to travel through the reservoir. The oscillating member may be operably coupled to an oscillating, moving, or otherwise non-static portion of the steering assembly (e.g., a lever arm coupled to a steering wheel). Movement of the non-static portion of the steering assembly causes movement of the oscillating rod through the reservoir which directs hydraulic fluid through the valve. This directs hydraulic fluid through the valve in the hydraulic damper, thus damping or reducing oscillations of the steering assembly (e.g., the non-static portion of the steering assembly).

Hydraulic dampers are also useful in vehicle suspensions. Regardless of the implementation, a hydraulic damper may include a hydraulic rebound stop assembly. Some hydraulic rebound stop assemblies include a first or lower collar, a sealing ring, a second or upper ring, and a rebound bumper. The upper ring and the rebound bumper may cooperate to absorb kinetic energy of the system, thereby reducing the speed at which the hydraulic damper moves to dampen oscillations of the steering assembly. Hydraulic dampers including distinct upper rings and rebound rings, however, may be complex to manufacture and tedious to assemble.

Thus, the continued development of hydraulic dampers has been directed to achieving a hydraulic damper including a hydraulic rebound stop assembly that is capable of absorbing kinetic energy while improving efficiency and reducing cost of manufacturing and assembly.

### SUMMARY

This section provides a general summary of the disclosure and is not a comprehensive disclosure of its full scope or all of its features.

The present disclosure provides the art with a hydraulic rebound stop assembly for a hydraulic damper. The rebound stop assembly includes a movable rod, a retention feature fixed to the movable rod, and a ring circumscribing and slidingly engaging the movable rod. The ring axially extends between a first end surface and an axially spaced apart second end surface. The ring includes an outer wall and an inner wall defining a cavity. The retention feature is at least partially received in the cavity. The ring is axially movable between a first position and a second position. A dimension of the cavity is greater than a dimension of axial travel of the ring between the first position and the second position. In the first position, the retention feature constrains axial movement of the ring in a first direction.

The present disclosure further provides the art with another hydraulic rebound stop assembly for a hydraulic damper. The rebound stop assembly includes a movable rod, a retention feature fixed to the movable rod, and a ring slidingly engaged to the movable rod. The ring axially extends between a first end surface and an axially spaced apart second end surface. The ring includes an outer wall, and inner wall, and a first stop proximate to the first end surface. The inner wall defines a cavity between the first stop and the second end surface. The ring is axially movable between a first position and a second position. The retention feature is at least partially received in the cavity when the ring is located at the first position, the second position, and positions therebetween to limit axial movement of the ring. A range of motion of the ring between the first position and the second position is less than an axial extent of the cavity.

The present disclosure also provides the art with a method of assembling a hydraulic rebound stop assembly for a hydraulic damper. The method includes fixing a collar to a movable rod. The method further includes sliding a first ring onto the movable rod. The method further includes sliding a second ring onto the movable rod. The second ring axially extends between a first end surface and an axially spaced apart second end surface. The second ring includes an outer wall and an inner wall defining a cavity. A retention feature fixed to the movable rod is at least partially received in the cavity when the second ring is located at a first position, a second position, and positions therebetween to limit axial movement of the second ring. The retention feature constrains the axial movement of the second ring.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic of a vehicle including a hydraulic damper in accordance with the present disclosure;

FIG. 2 is a cross-sectional view of a hydraulic damper in accordance with the present disclosure;

FIG. 3 is a front view of a hydraulic rebound stop assembly including a ring in accordance with the present disclosure;

FIG. 4A is a cross-sectional view of the hydraulic rebound stop assembly of FIG. 3 in a first position;

FIG. 4B is a cross-sectional view of the hydraulic rebound stop assembly of FIG. 3 in a second position;

FIG. 5 is a cross-sectional view of another ring included in a hydraulic rebound stop assembly;

FIG. 6A is a cross-sectional view of another hydraulic rebound stop assembly in a first position;

FIG. 6B is a cross-sectional view of the hydraulic rebound stop assembly of FIG. 6A in a second position;

FIG. 7A is a perspective view of another ring included in a hydraulic rebound stop assembly in accordance with the present disclosure;

FIG. 7B is a cross-sectional view of the ring of FIG. 7A taken along line 7B-7B;

FIG. 7C is a cross-sectional view of the ring of FIG. 7A taken along line 7C-7C; and

FIG. 8 is a flowchart of a method of assembling a hydraulic rebound stop assembly for a hydraulic damper in accordance with the present disclosure.

Corresponding reference numerals indicate corresponding parts throughout the several views of the drawings.

### DETAILED DESCRIPTION

Example embodiments will now be described more fully with reference to the accompanying drawings.

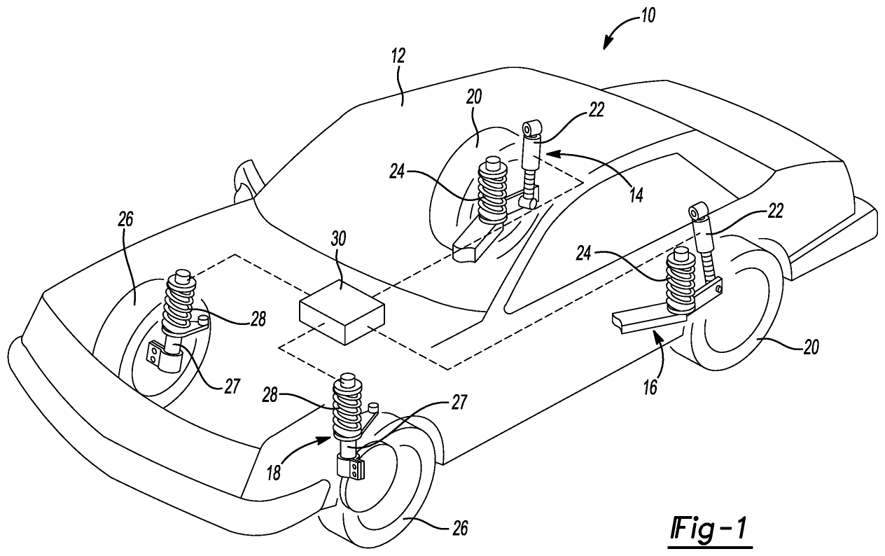

Referring now to the drawings in which like reference numerals designate like or corresponding parts throughout the several views, there is illustrated in FIG. 1, a vehicle 10 including a body 12 and a suspension system 14. Body 12 may cooperate with other structures in the vehicle to define a passenger compartment. Suspension system 14 may include a rear suspension 16 and a front suspension 18.

Rear suspension 16 includes a transversely extending rear axle assembly (not shown) adapted to support a pair of rear wheels 20. The rear axle assembly is operatively connected to body 12 through a pair of hydraulic dampers 22 and a first pair of helical coil springs 24. Similarly, front suspension 18 includes a transversely extending front axle assembly (not shown) adapted to support a pair of front wheels 26. The front axle assembly is operatively connected to body 12 through another pair of hydraulic dampers 27 and a second pair of helical coil springs 28. Although the embodiment of FIG. 1 depicts front and rear axle assemblies 16, 18, it is contemplated that vehicle 10 includes an independent suspension for each or the four wheels and/or corners of vehicle 10.

Hydraulic dampers 22, 27 are adapted to dampen movement of suspension system 14 relative to body 12. Hydraulic dampers 22 may include shock absorbers, MacPherson struts, semi-active (e.g., a Continuously Variable Semi-Active (CVSA) dampers, and active suspension devices, for example.

To adjust (e.g., automatically adjust) each of hydraulic dampers 22, 27 an electronic controller 30 is electrically connected to hydraulic dampers 22, 27. Electronic controller 30 may control an operation of each of hydraulic dampers 22, 27 to achieve the desired damping characteristics of the suspension system 14 and body 12 (i.e., electronic controller and hydraulic dampers 22, 27 may cooperate to achieve the desired movement between suspension system 14 and body 12). In one example, electronic controller 30 may independently control each of the hydraulic dampers 10 such that each of the hydraulic dampers 22, 27 have different damping characteristics. Electronic controller 30 may be connected to hydraulic dampers 22, 27 via wired connections, wireless connections, or combinations thereof. Each of the hydraulic dampers 22, 27 may include a dedicated electronic controller that is positioned on the respective hydraulic damper. Additionally or alternately, the functionalities of electronic controller 30 may be performed by an Electronic Control Unit (ECU) (not shown) of vehicle 10. Electronic controller 30 may include a processor, a memory, Input/Output (1/O) interfaces, communication interfaces and other components. The processor may execute various instructions stored in the memory for carrying out various operations of electronic controller 30. Electronic controller 30 may receive and transmit signals and data through I/O interfaces and communication interfaces. Electronic controller 30 may further include microcontrollers, application-specific integrated circuits (ASICs), field programmable gate arrays (FPGAs), etc.

Electronic controller 30 may independently adjust the damping level or characteristic of each of the hydraulic dampers 22, 27 to optimize a ride performance of vehicle 10. As used herein, “damping level” is a damping force produced by each of the hydraulic dampers 22, 27 to counteract movements or vibration of body 12 and/or to counteract movements or vibrations of wheels 20, 26. A higher damping level corresponds to a relatively higher damping force while a lower damping level corresponds to a relatively lower damping force. Adjustments of damping levels are beneficial during the ride handling of vehicle 10, such as during braking and/or turning of vehicle 10.

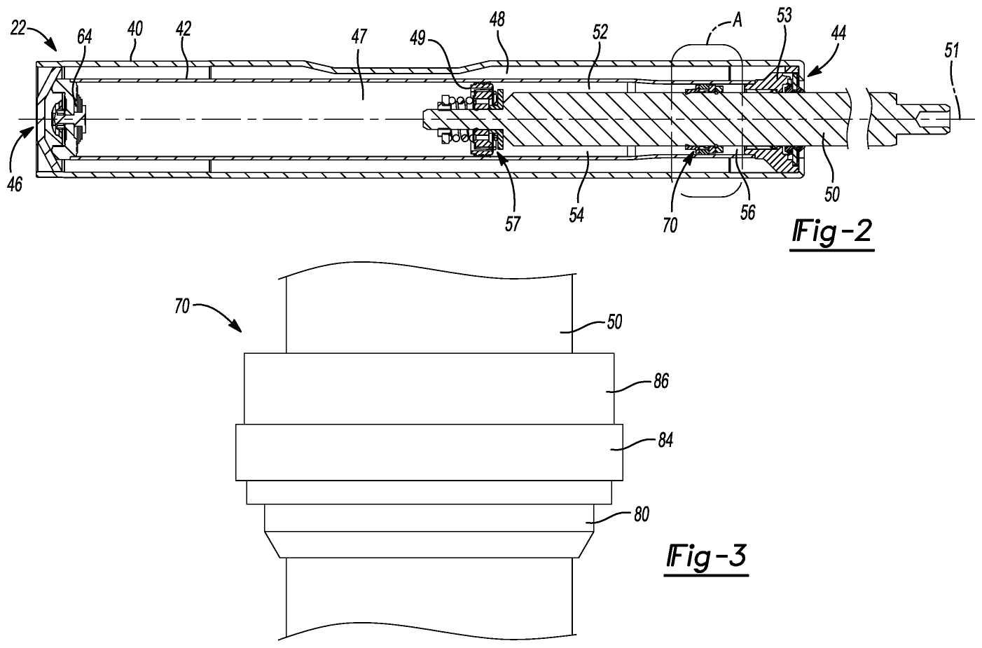

Referring to FIG. 2, hydraulic damper 22 contains a fluid (e.g., hydraulic fluid and/or oil) disposed therein. Hydraulic damper 22 includes an outer tube 40 and an inner or pressure tube 42 (e.g., a monolithic pressure tube) disposed concentrically within outer tube 40. Pressure tube 42 extends between a first end 44 and a second end 46 opposite the first end 44. Outer tube 40 and pressure tube 42 are generally cylindrical in shape, although other shapes and configurations may be utilized. While a double-tube damper is shown in the configuration of FIG. 2, it is contemplated that other dampers, such as mono-tube dampers, may also be utilized.

A compression chamber 47 is defined by pressure tube 42, a piston 49, and a base valve 64. Outer tube 40 and pressure tube 42 cooperate to define a reserve chamber 48. Reserve chamber 48 is in fluid communication with an external fluid reservoir (not shown). For example, reserve chamber 48 may be fluid communication with an accumulator. A valve assembly (not shown) may selectively permit fluid communication between reserve chamber 48 and external reservoir. In such examples, the valve assembly may regulate a flow of fluid between reserve chamber 48 and the external fluid reservoir.

Piston 49 is fixed to a movable rod 50 and slidably disposed within pressure tube 42. Movable rod 50 defines an axis 51 of hydraulic damper 22. A rebound chamber 52 is defined between piston 49, pressure tube 42, a bearing assembly 53, and movable rod 50. Rebound chamber 52 includes a first rebound chamber 54 and a second rebound chamber 56. Each of the first rebound chamber 54 and second rebound chamber 56 contain fluid therein. A volume of each of the first and second rebound chambers 54,56 varies based on a reciprocating motion of piston 49 within pressure tube 42. At least one piston valve 57 may be disposed within piston 49 to regulate fluid flow between first and second rebound chambers 54, 56 and compression chamber 47. In other words, by selectively permitting fluid flow between first and second rebound chambers 54, 56, and compression chamber 47, piston valves 57 may maintain a desired pressure in each of the first and second rebound chambers 54, 56.

Piston 49 is connected to body 12 of vehicle 10 (FIG. 1) via movable rod 50. Movable rod 50 is at least partially received in pressure tube 42. For example, at least a portion of movable rod 50 extends through first end 44 of pressure tube 42.

Hydraulic damper 22 may include the base valve 64 positioned proximate to second end 46 of pressure tube 42. Base valve 64 may selectively permit fluid flow between compression chamber 47 and reserve chamber 48. At least one of the piston valves 57 and base valve 64 may be electronically controlled by electronic controller 30 (FIG. 1) such that the electronic controller 30 may regulate the piston valves 57 and/or base valve 64 to control the damping level of hydraulic damper 22.

A hydraulic rebound stop assembly 70 (i.e., a sealing assembly) (hereafter “rebound stop assembly 70”), is coupled to movable rod 50 and disposed within pressure tube 42. Rebound stop assembly 70 is positioned proximate to first end 44 of pressure tube 42 in between first end 44 and piston 49. Rebound stop assembly 70 is disposed within a portion of rebound chamber 52. Specifically, rebound stop assembly 70 is disposed between first rebound chamber 54 and second rebound chamber 56. In other words, rebound stop assembly 70 separates first rebound chamber 54 and second rebound chamber 56 within pressure tube 42. Rebound stop assembly 70 is adapted to at least partially seal, limit, or reduce a flow of fluid between first rebound chamber 52 and the second rebound chamber 54.

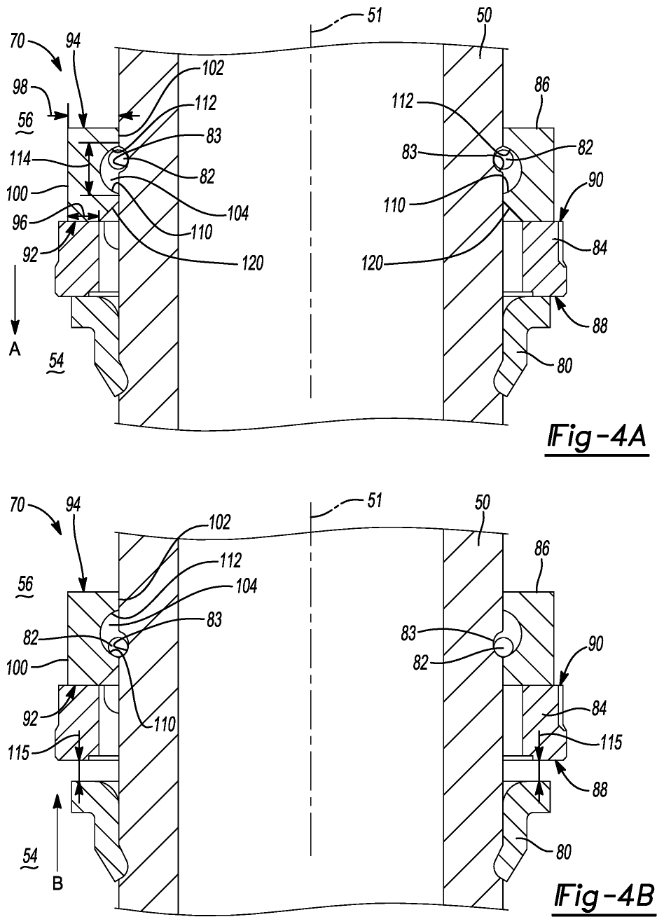

FIGS. 3 and 4A-4B are enlarged views of the rebound stop system 70 as shown in portion A of hydraulic damper 22 of FIG. 2. Rebound stop system 70 includes a collar 80, a retention feature 82 (FIGS. 4A-4B), a first or sealing ring 84, and a second or retainer ring 86.

Collar 80 is an annular member circumscribed around movable rod 50. In other words, a portion of movable rod 50 extends through collar 80. Collar 80 may be fixed to movable rod 50 (e.g., by crimping) such that collar 80 does not slide along axis 51 of movable rod 50. Collar 80 may be formed of a metallic material.

Retention feature 82 is adapted to limit an axial range of motion of second ring 86 in at least one direction. In some configurations, retention feature 82 may include one or more radially extending protrusions connected to movable rod 50. Retention feature 82 may include protrusions that are integrally formed with movable rod 50. As shown in the configuration of FIGS. 4A-4B, retention feature 82 may be a wire (e.g., a metallic wire) that is snap-fit around movable rod 50. Retention feature 82 may be received in a groove 83 defined around a periphery of movable rod 50 and fixed to movable rod 50 such that retention feature 82 does not slide along axis 51 of movable rod 50 when movable rod 50 reciprocates. In one example, retention feature 82 is a circlip.

Sealing ring 84 is an annular member circumscribed around and slidingly engaged to movable rod 50. Sealing ring 84 axially extends between a first end surface 88 and an axially spaced second end surface 90. Sealing ring 84 may be formed of a polymeric material.

Second ring 86 is an annular member circumscribed around and slidingly engaged to movable rod 50. As will be discussed in greater detail below, second ring 86 is adapted to move along axis 51 of movable rod 50 between a first position (FIG. 4A) and a second position (FIG. 4B). In the configuration shown in FIGS. 3 and 4A-4B, second ring 86 is axially asymmetric. Second ring 86 extends between a first end surface 92 and an axially spaced apart second end surface 94. First end surface 92 has a first dimension or radial width 96 that is smaller than a second dimension or radial width 98 of second end surface 94. Second ring 86 further includes an outer wall 100 and an inner wall 102 spaced radially inward from outer wall 100.

Inner wall 102 defines a cavity 104 extending between a first stop 110 proximate to first end surface 92 and a second stop 112 proximate to second end surface 94. Cavity 104 is defined by a concave surface such that each of the first stop 110 and the second stop 112 contact, or may be slightly spaced apart from, movable rod 50. As shown in the configuration of FIGS. 4A-4B, cavity 104 has a semi-circular cross-section, although other shapes and cross-sections are contemplated.

A height 114 between first stop 110 and second stop 112 (i.e., an axial extent of cavity 104) may be greater than a dimension of axial travel of second ring 86 relative to movable rod 50. Height 114 may be greater than or equal to about 0.5 millimeters (mm) to less than or equal to about 3 mm. More narrowly, the height 114 may be greater than or equal to about 1 mm to less than or equal to about 2 mm.

Second ring 86 includes a chamfer 120 extending between first stop 110 and first end surface 92. Chamfer 120 extends radially outward from first stop 110 at an angle with respect to axis 51. The angle may be greater than or equal to about 20 degrees to less than or equal to about 70 degrees, or more narrowly, greater than or equal to about 20 degrees to less than or equal to about 45 degrees. Chamfer 120 enables efficient assembly of rebound stop assembly 70 by reducing or minimizing the force required to slide second ring 86 over retention feature 82.

Second ring 86 is adapted to absorb energy from the impact of other components during operation of hydraulic damper 22 (i.e., second ring 86 acts as a rebound or spring). Second ring 86 is comprised of a material having a flexibility (e.g., an elastic deformation) sufficient to slide over retention feature 82 during assembly while maintaining desired strength and stiffness to absorb impact energy during operation of rebound stop assembly 70. Second ring 86 may be comprised of a polymeric material. For example, second ring 86 may be formed of a polyamide (e.g., nylon, PA66, PA46, etc.) a polyurethane (PUR), a polycarbonate (PC), a polymethyl methacrylate (PMMA), a polyethylene terephthalate (PET), a polyacrylic (acrylic), co-polymers thereof, and combinations thereof. Second ring 86 may be formed by molding processes (e.g., injection molding).

Retainer feature 82 is received within cavity 104 and limits the axial motion of second ring 86 in at least one direction. For example, second ring 86 may circumscribe retainer feature 82 what at the first position, second position, and positions therebetween. In the configuration of FIGS. 4A-4B collar 80 and sealing ring 82 may cooperate to limit the axial motion of second ring 86 in a first direction A (FIG. 4A) by engaging first end surface 92. Retainer feature 82 may limit the axial motion of second ring 86 in a second direction B (FIG. 4B) by engaging or trapping first stop 110. In this way second ring 86 moves between a first position (FIG. 4A) and a second position (FIG. 4B) along axis 51 of movable rod 50.

During operation of rebound stop assembly 70, movable rod 50 moves between a rebound stroke (FIG. 4A) and a compression stroke in (FIG. 4B). First rebound chamber 54 and second rebound chamber 56 are defined by their respective pressures relative to each other. The pressures within first rebound chamber 54 and second rebound chamber 56 change based on the position of movable rod 50 moving between a rebound stroke and a compression stroke. For example, during a rebound stroke, the fluid in the second rebound chamber 56 is at a higher pressure than the fluid within the first rebound chamber 54. As more fluid moves into first rebound chamber 54 and the compression stroke begins, the pressure in the first rebound chamber 54 is higher than the pressure in the second rebound chamber 56. This oscillation in pressure via the movement of fluid between first rebound chamber 54 and second rebound chamber 56 during rebound and compression strokes enables the damping capabilities of hydraulic damper 22.

As shown in FIG. 4A, during the rebound stroke, fluid from second rebound chamber 56 flows towards the first rebound chamber 54. First end surface 88 of sealing ring 84 contacts collar 80. Second end surface 90 of sealing ring 84 contacts first end surface 92 of second ring 86. Collar 80 and sealing ring 84 may cooperate to limit the extent of axial travel of second ring 86 in direction A. As shown in FIG. 4A, in the first position, retention feature 82 may be spaced apart from second stop 112 of second ring 86. In this way, during the rebound stroke, second ring 86 may absorb energy from impact with fluid and/or other components of hydraulic damper 22 to protect retention feature 82. Additionally or alternately, it is contemplated that retention feature 82 may engage second stop 112 of second ring 86 to limit axial movement of second ring 86 in direction A.

As shown in FIG. 4B, during the compression stroke, fluid from first rebound chamber 54 flows towards the second rebound chamber 56. Sealing ring 84 and second ring 86 move to a second position. In the second position, sealing ring 84 and second ring 86 maintain contact. Sealing ring 84 is spaced apart from collar 80, forming a gap 115 therebetween. Retention feature 82 engages first stop 110 of second ring 86 to limit axial movement of second ring 86 in direction B.

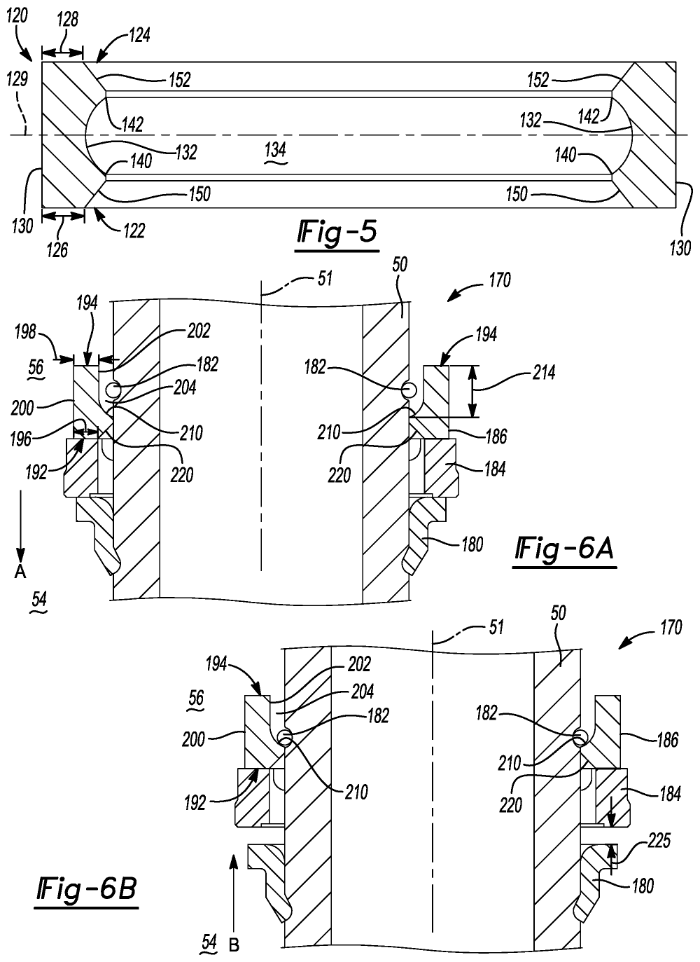

Referring to FIG. 5, a second ring 120 is shown, which may be the same as or similar to second ring 86 of FIGS. 3, and 4A-4B, except as described below. Second ring 120 may be used in rebound stop assembly 70.

Second ring 120 is an annular member extending between a first end surface 122 and an axially spaced apart second end surface 124. First end surface 122 has a first dimension or radial width 126 that is substantially similar to a second dimension or radial width 128 of second end surface 124. Second ring 120 further includes an outer wall 130 and an inner wall 132 spaced radially inward from outer wall 130. Geometry of second ring 120 may be symmetric about a longitudinal axis 129.

Inner wall 132 defines a cavity 134 extending between a first stop 140 proximate to first end surface 122 and a second stop 142 proximate to second end surface 124. Cavity 134 is defined by a concave surface such that each of the first stop 140 and the second stop 142 contact, or may be slightly spaced apart from, movable rod 50.

Second ring 120 includes a first chamfer 150 extending between first stop 140 and first end surface 122. First chamfer 150 extends radially outward from first stop 140 at a first angle. Second ring 120 includes a second chamfer 152 extending between second stop 142 and second end surface 124. Second chamfer 152 extends radially outward from second stop 142 at a second angle. First angle is substantially the same as second angle such that second ring 120 is axially symmetric (i.e., ring 120 is symmetric about longitudinal axis 129). Because second ring 120 is symmetric, it may be assembled in either orientation. In this way, second ring 120 has designed-in error proofing features (e.g., a designed in poka-yoke) for assembly of rebound stop assembly 70, thus reducing or preventing operator error during manufacturing.

With reference to FIGS. 6A-6B, a rebound stop assembly 170 is shown. Rebound stop assembly 170 may be the same as or similar to rebound stop assembly 70 of FIGS. 3 and 4A-4B, except as otherwise described below. Rebound stop assembly 170 includes a collar 180, a retention feature 182, a first or sealing ring 184, and a second or retainer ring 186.

Second ring 186 is an annular member circumscribed around and slidingly engaged to movable rod 50. Second ring 186 is adapted to move along axis 51 of movable rod 50 between a first position (FIG. 6A) and a second position (FIG. 6B). In the configuration shown in FIGS. 6A-6B, second ring 186 is axially asymmetric. Second ring 186 extends between a first end surface 192 and an axially spaced second end surface 194. First end surface 192 has a first dimension or radial width 196 that is substantially similar to a second dimension or radial width 198 of second end surface 194. Second ring 186 includes an outer wall 200 and an inner wall 202 spaced radially inward from outer wall 200.

Inner wall 202 defines a cavity 204 (e.g., an open cavity) extending axially between a first stop 210 proximate to first end surface 192 and second end surface 194. First stop 210 contacts or may be slightly spaced apart from movable rod 50. A height 214 or axial extent between first stop 210 and second end surface 194 may be greater than a dimension of axial travel of second ring 186 relative to movable rod 50. In this way, second end surface 194 of second ring 186 extends past retention feature 182 in both the first position (FIG. 6A) and the second position (FIG. 6B). Stated another way, second ring 186 circumscribes retention feature 182 when at the first position, the second position, and positions therebetween. The axial position of second end surface 194 relative to retention feature 182 enables second ring 186 to absorb energy from impact with fluid and/or other components of hydraulic damper 22 during operation to protect retention feature 182. Height 214 may be greater than or equal to about 0.5 mm to less than or equal to about 4 mm, or more narrowly, greater than or equal to about 1 mm to less than or equal to about 3 mm.

The configuration of cavity 204 enables second ring 186 to be molded in a single axial pulling direction. A second ring 186 that is moldable in a single axial pulling direction may improve manufacturing cost and efficiency as compared to a second ring that requires more than one axial pulling direction, or otherwise requires the cavity to be formed in the ring by removing a molded feature.

Second ring 186 includes a chamfer 220 extending between first stop 210 and first end surface 192. Chamfer 220 extends radially outward from first stop 210 at an angle.

During operation of rebound stop assembly 170, movable rod 50 moves between a rebound stroke (FIG. 6A) and a compression stroke (FIG. 6B). As shown in FIG. 6A, during the rebound stroke, sealing ring 184 and second ring 186 are in the first position. Sealing ring 184 is in contact with both collar 180 and second ring 186. Retention feature 182 is received within cavity 204 and spaced apart from first stop 210. As shown in FIG. 6B, sealing ring 184 and second ring 186 are in the second position. Sealing ring 184 is in contact with first end surface 192 of second ring 186. Sealing ring 184 is spaced apart from collar 180 forming a gap 225 therebetween. Retention feature 182 engages first stop 210 of second ring 186 to limit axial movement of second ring in direction B. As shown in the configuration of FIGS. 6A-6B, retention feature 182 limits axial movement of second ring 186 in only one direction. Collar 180 and sealing ring 184 limit the extent of axial travel of second ring 186 in the opposite direction.

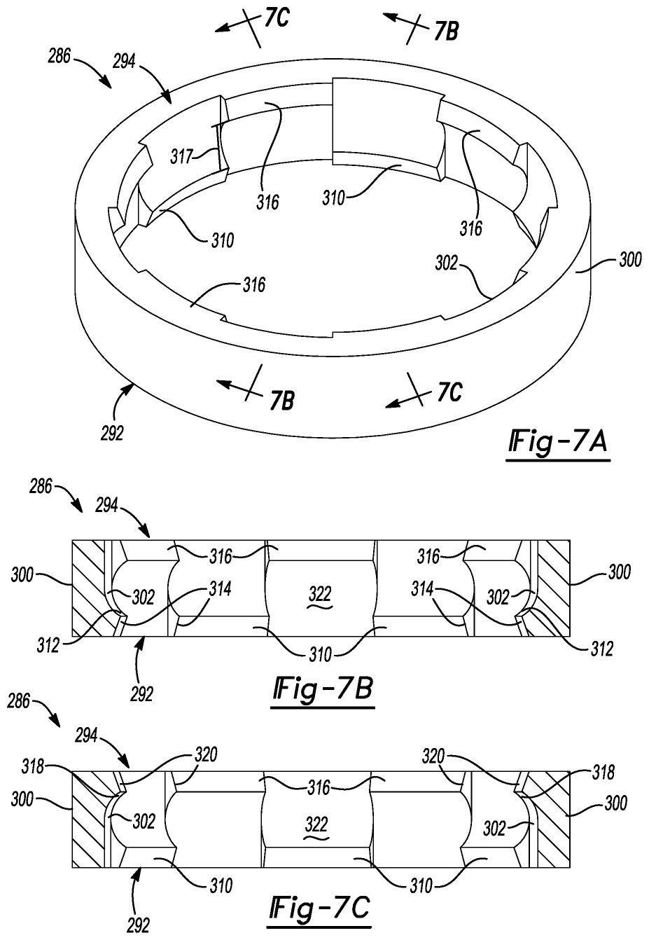

Referring to FIGS. 7A-7C, an alternate embodiment second ring is identified at reference numeral 286. Second ring 286 may be the same as or similar to second ring 86 of FIGS. 3 and 4A-4B or second ring 186 of FIGS. 6A-6B, except as described below. In the configurations shown in FIGS. 7A-7C, second ring 286 is axially symmetric. Second ring 286 is an annular member circumscribed around and slidingly engaged to movable rod 50. Second ring 286 extends between a first end surface 292 and an axially spaced apart second end surface 294. Second ring 286 includes an outer wall 300 and an inner wall 302 spaced radially inward from outer wall 300.

A first plurality of protrusions 310 extend radially inward from first end surface 292. Each of the first plurality of protrusions 310 includes a first stop 312. As best shown in FIG. 7B, each of the first plurality of protrusions 310 define a first chamfer 314 extending at a first angle from first stop 312 to first end surface 292.

A second plurality of protrusions 316 extend radially inward from second end surface 294. Each of the second plurality of protrusions 316 includes a second stop 318. As best shown in FIG. 7C, each of the second plurality of protrusions 316 define a second chamfer 320 extending at a second angle from second stop 318 to second end surface 294. Second angle may be the same as first angle.

First plurality of protrusions 310 and second plurality of protrusions 316 alternate around the periphery of inner wall 302 such that first plurality of protrusions 310 and second plurality of protrusions form a staggered castellation. The staggered castellation is axially symmetric such that it can be assembled in the rebound stop assembly in either direction (e.g., a designed in poka-yoke). A cavity 322 is defined between inner wall 302, first plurality of protrusions 310, and second plurality of protrusions 316. A dimension 317 of cavity 322 between the first plurality of protrusions 310 and the second plurality of protrusions 316 may be greater a dimension of axial travel of second ring 286 relative to a movable rod (e.g., movable rod 50 of FIGS. 3 and 4A-4B). Second ring 286 may be molded in a single axial pulling direction.

During operation of the rebound stop assembly, second ring 286 moves between a first position and a second position. During a rebound stroke, a collar and a sealing ring (e.g., collar 80 and sealing ring 84 of FIGS. 3 and 4A-4B) cooperate to limit the extent of axial travel of second ring 286 by engaging the first end surface 292 of second ring 286. A retention feature (e.g., retention feature 82 of FIGS. 3 and 4A-4B or retention feature 182 of FIGS. 6A-6B) may also engage second plurality of protrusions 316 at the respective second stops 318 to limit axial travel of second ring 286. Conversely, during a compression stroke, the retention feature engages first plurality of protrusions 310 at the respective first stops 312. In this way, axial movement of second ring 286 is restricted by the retention feature in at least one direction during operation of the rebound stop assembly.

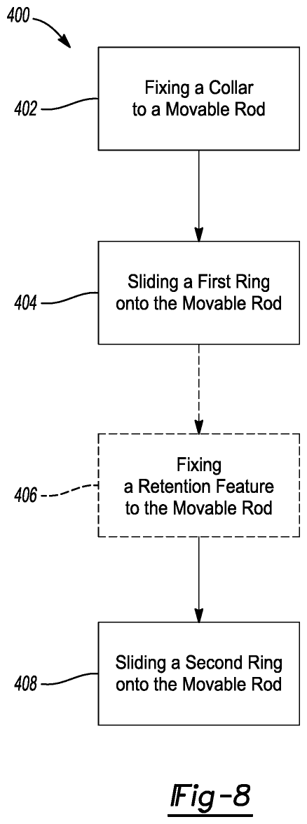

With reference to FIG. 8, a method 400 of assembling a rebound stop assembly for a hydraulic damper is provided. First, at 402, method 400 includes fixing a collar to a movable rod (e.g., by crimping). Next, at 404, method 400 includes sliding a first ring onto the movable rod. The first ring may contact the collar. Next, at 406, the method 400 optionally includes fixing a retention feature to the movable rod (e.g., when the retention feature is not integrally formed with movable rod). In one example, a circlip may be snap-fit onto the movable rod and received in a groove of the movable rod. Next, at 408, the method 400 includes sliding a second ring onto the movable rod. At least one chamfer in the second ring enables the second ring to slide over the retention feature. As assembled, the retention feature is received within a cavity of the second ring.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A rebound stop assembly for a hydraulic damper, the rebound stop assembly comprising:
a movable rod;
a retention feature fixed to the movable rod; and
a ring circumscribing and slidingly engaging the movable rod, the ring axially extending between a first end surface and an axially spaced apart second end surface, the ring including an outer wall and an inner wall defining a cavity, the retention feature being at least partially received in the cavity,
wherein the ring is axially movable between a first position and a second position,
wherein a dimension of the cavity is greater than a dimension of axial travel of the ring between the first position and the second position, and
wherein in the first position, the retention feature constrains axial movement of the ring in a first direction.

2. The rebound stop assembly of claim 1, the ring further comprising a first stop proximate to the first end surface and a second stop proximate to the second end surface, wherein the dimension of the cavity is defined between the first stop and the second stop.

3. The rebound stop assembly of claim 2, wherein the dimension of the cavity is greater than or equal to about 1 millimeter to less than or equal to about 3 millimeters.

4. The rebound stop assembly of claim 2, wherein, in the first position, the retention feature engages the first stop.

5. The rebound stop assembly of claim 2, wherein the ring includes a first chamfer extending between the first stop and the first end surface.

6. The rebound stop assembly of claim 5, wherein the ring includes a second chamfer extending between the second stop and the second end surface.

7. The rebound stop assembly of claim 6, wherein a first angle of the first chamfer is the same as a second angle of the second chamfer.

8. The rebound stop assembly of claim 1, the ring further comprising,
a first plurality of protrusions extending radially inward from the first end surface, each of the first plurality of protrusions including a first stop, and
a second plurality of protrusions extending radially inward from the second end surface, each of the second plurality of protrusions including a second stop.

9. The rebound stop assembly of claim 8, wherein the first plurality of protrusions and the second plurality of protrusions alternate around a circumference of the inner wall to form staggered castellations.

10. The rebound stop assembly of claim 8, wherein the cavity is defined by the inner wall, the first plurality of protrusions, and the second plurality of protrusions and the dimension of the cavity is defined between the first plurality of protrusions and the second plurality of protrusions.

11. The rebound stop assembly of claim 10, wherein, in the first position, the retention feature engages at least one of the first stops.

12. The rebound stop assembly of claim 1, further comprising a collar fixed to the movable rod and a sealing ring sealing ring circumscribing and slidingly engaging the movable rod, the sealing ring disposed between the collar and the ring, wherein the collar and the sealing ring cooperate to constrain axial movement of the ring in a second direction.

13. The rebound stop assembly of claim 1, wherein the ring comprises a polymeric material.

14. The rebound stop assembly of claim 1, wherein the ring is axially symmetric.

15. The rebound stop assembly of claim 1, wherein the retention feature is a circlip.

16. A rebound stop assembly for a hydraulic damper, the rebound stop assembly comprising:
a movable rod;
a retention feature fixed to the movable rod; and
a ring slidingly engaged to the movable rod, the ring axially extending between a first end surface and an axially spaced apart second end surface, the ring including an outer wall, an inner wall, and a first stop proximate to the first end surface, the inner wall defining a cavity between the first stop and the second end surface,
wherein,
the ring is axially movable between a first position and a second position,
the retention feature being at least partially received in the cavity when the ring is located at the first position, the second position, and positions therebetween to limit axial movement of the ring, and
a range of motion of the ring between the first position and the second position being less than an axial extent of the cavity.

17. The rebound stop assembly of claim 16, wherein in the first position, the retention feature engages the first stop and constrains axial movement of the ring in a first direction.

18. The rebound stop assembly of claim 16, wherein the ring includes a chamfer extending between the first stop and the first end surface.

19. The rebound stop assembly of claim 16, further comprising a collar fixed to the movable rod and a sealing ring circumscribing and slidingly engaging the movable rod, wherein
the sealing ring is disposed between the ring and the collar,
the sealing ring contacts the ring,
when in the first position, the sealing ring is spaced apart from the collar, and
when in the second position, the sealing ring contacts the collar.

20. A method of assembling a hydraulic rebound stop assembly for a hydraulic damper, the method comprising:
fixing a collar to a movable rod;
sliding a first ring onto the movable rod; and
sliding a second ring onto the movable rod, the second ring axially extending between a first end surface and an axially spaced apart second end surface, the second ring including an outer wall and an inner wall defining a cavity, wherein a retention feature fixed to the movable rod is at least partially received in the cavity when the second ring is located at a first position, a second position, and positions therebetween to limit axial movement of the second ring, and wherein the retention feature constrains the axial movement of the second ring.
